(19) United States
(12) Patent Application Publication
(10) Pub. No.: US 2002/0131624 A1
(43) Pub. Date: Sep. 19, 2002

(54) Fingerprint imaging device with fake finger detection

(76) Inventors: Yury Shapiro, San Ramon, CA (US); Alexandre Ryabov, St. Petersburg (RU)

Correspondence Address: WILLIAM J. EGAN, III, Fish & Richardson P.C., Suite 100, 2200 Sand Hill Road, Menlo Park, CA, 94025, US

(21) Appl. No.: 09/963,906

(22) Filed: Sep. 25, 2001

Related U.S. Application Data
(63) Continuation-in-part of application No. 09/637,063, filed on Aug. 11, 2000.

(51) Int. Cl. G06K 9/00

(52) U.S. Cl. 382/124

(57) ABSTRACT

A fingerprint imaging device includes an optical plate having a finger receiving surface for creating an image of a fingerprint pattern. The fingerprint pattern is illuminated with light from an illuminating tool to create imaging light rays. The imaging light rays from the fingerprint pattern are received by an imaging lens that projects an image of the fingerprint pattern to an image sensor. Another light source is provided to project a light beam onto finger receiving surface. This light source is used to determine whether an object on the finger receiving surface is real or fake.

### CROSS REFERENCE TO RELATED APPLICATIONS

This application is a continuation-in-part of U.S. patent application Ser. No. 09/637,063, filed Aug. 11, 2000, the entire disclosure of which is incorporated herein by reference.

### TECHNICAL FIELD

This invention relates to fingerprint imaging devices for fingerprint matching systems.

### BACKGROUND

Up-to-date fingerprint matching systems using fingerprint image transfer into electronic data usually apply the known contact method to create a fingerprint pattern. A surface topography of a finger is approximated by a series of ridges with intermediate valleys. When a finger is applied to a surface of a transparent optical plate or prism, the ridges contact the optical plate while the valleys do not and instead serve to form the boundaries of regions of air and/or moisture.

The finger to be imaged is illuminated by a light source located below or near to the optical plate. Imaging light from the light source is incident on the surface of the optical plate at an angle of incidence measured with respect to a normal to that surface. Imaging light reflected from the surface is detected by an imaging system that usually includes some form of a detector.

Components of a typical fingerprint imaging system are oriented so that an angle of observation (defined to be an angle between an optical axis of the imaging system and the normal to the optical plate surface) is greater than a critical angle for the interface between the surface and the air at the surface. The critical angle at the surface/air interface is defined as the smallest angle of incidence for which imaging light striking the surface/air interface is totally internally reflected within the optical plate. Therefore, the critical angle at the surface/air interface depends on the index of refraction of the air and the optical plate. Another constraint for the angle of observation arises because there is incentive to observe the image at the smallest practical angle of observation, as this reduces distortion due to object tilting. Therefore, the angle of observation is typically chosen to be close to, but greater than the critical angle at the surface/air interface.

At locations where the ridges of the finger contact the surface of the optical plate, total internal reflection does not occur because the index of refraction of a finger is larger than that of air. In this case, imaging light incident on the surface of the optical plate at a location where the ridge of the finger contacts the surface is refracted through the surface/finger interface and then partially absorbed and partially diffused upon contact with the finger. In this case, only a small fraction of incident imaging light is reflected back to a detector of the imaging system.

The imaging system may be implemented to produce bright components at valley locations and dark components at ridge locations, thus producing a dark or positive fingerprint pattern. Here, the imaging system detects the imaging light reflected from the surface/air interface. Alternatively, the imaging system may be implemented to produce bright components at ridge locations and dark components at valley locations, thus producing a bright or negative fingerprint pattern. In this case, the imaging system detects a small percentage of the imaging light that is diffused upon contact with the finger.

A fingerprint may be used as an access key to, for example, an electronic device. Attempts may be made to gain unauthorized access to such a device by forging the key by using a false finger.

### SUMMARY

In one aspect, the inventions features an imaging device. The imaging device comprises an optical plate made of an optically transparent material and forming a surface to receive a finger. A first light source is positioned to illuminate the finger receiving surface. An imaging system is positioned to receive light collected from the finger receiving surface and to form an image of a fingerprint pattern of a finger on the finger receiving surface. A second light source directs a light beam to the finger receiving surface to determine whether an object on that surface is real or fake.

Various implementations of the invention may include one or more of the following features. The light beam from the second light source has a central axis that is normal to the finger receiving surface. The light beam from the second light source has a central axis that is inclined at an angle from normal relative to the finger receiving surface. The image area of the light beam from the second light source is substantially less than the surface area of the finger receiving surface. The diameter of the image area of the light beam from the second light source is between about one and three millimeters. The second light source is selected from the group consisting of a light-emitting diode, a laser and a laser diode. The optical plate has a second surface parallel to the finger receiving surface, and the second light source is located below the second surface of the optical plate. The first light source is positioned at the second surface of the optical plate. A reflective surface is positioned at a third surface of the optical plate to collect light from the finger receiving surface and to focus the collected light on the imaging system. The imaging system is positioned at a fourth surface of the optical plate. The reflective surface is a converging mirror, a diverging mirror or an array of microreflectors. The imaging system comprises an aperture at a second surface of the optical plate, an objective at the aperture, and a detector to receive light collected by the aperture and the objective. The imaging system comprises a reflective surface positioned between the objective and the detector for collecting light from the objective and for focusing the light onto the detector. The detector is either a CCD or a CMOS sensor. The aperture defines an aperture beam of light rays used by the detector.

In another aspect, the invention is directed to an imaging device having an optical plate made of an optically transparent material and forming a surface for receiving a finger. A first light source is positioned to illuminate the finger receiving surface. A second light source directs a light beam toward the finger receiving surface to form an image of limited area at or near the finger receiving surface. An imaging system is positioned to receive light from the finger receiving surface and to form an image of a fingerprint pattern of a finger on the finger receiving surface. The imaging system is also configured and operable to locate the position of the image formed by the second light source along an axis of the finger receiving surface and to compare that position to a predetermined reference value to determine whether an object on the finger receiving surface is real or fake.

Various implementations of the invention may include one or more of the following features. The predetermined reference value is stored in memory, and it is the position of an image formed along the axis of the finger receiving surface by a real finger. A predetermined offset value is also stored in memory. The predetermined offset value is the approximate difference between the predetermined reference value and the position of an image formed along the axis of the finger receiving surface by a fake or false finger. The imaging system further includes a processor to compare the predetermined reference value to the position of the image formed by the second light source along the axis of the finger receiving surface to generate a measured offset value. The measured offset value is compared to the predetermined offset value to determine whether the object on the finger receiving surface is real or false.

In yet another aspect, the invention is directed to an imaging device comprising an optical plate made of an optically transparent material and forming a surface for receiving a finger. A light source is provided to direct light to the finger receiving surface to form an image of limited size at or near the finger receiving surface to determine whether an object on the finger receiving surface is real or fake. An imaging system is positioned to receive light collected from the finger receiving surface to locate the position of the image formed by the light source along an axis of the finger receiving surface and to compare that position to a predetermined reference value to determine whether an object on the finger receiving surface is real or fake.

Various implementations of the invention may include one or more of the following features. The imaging system is configured and operable to form an image of a fingerprint pattern of a finger on the finger receiving surface.

In still another aspect, the invention is directed to an imaging device comprising an optical plate made of an optically transparent material and forming a surface for receiving a finger. A first light source is positioned to illuminate the finger receiving surface. A second light source directs a light beam toward the finger receiving surface to form an image of limited area at or near the finger receiving surface. An imaging system is positioned to receive light from the finger receiving surface and to form an image of a fingerprint pattern of a finger on the finger receiving surface. The imaging system includes means for locating the position of an image formed by the second light source along an axis of the finger receiving surface and comparing that position to a predetermined reference value to determine whether the object on the finger receiving surface is a real or fake.

In another aspect, the invention is directed to a method of imaging a fingerprint. The method comprises receiving an object at a finger receiving surface of an optical plate made of an optically transparent material. The finger receiving surface is illuminated by a first light source to form an image of limited size at or near the finger receiving surface. Light is collected from the finger receiving surface. The collected light is received at an imaging system to locate the position of the image along an axis of the finger receiving surface and to compare it to a predetermined reference value to determine whether the object on the finger receiving surface is a real or fake.

In still another aspect, the invention is directed to a method of imaging a fingerprint, comprising receiving an object at a finger receiving surface of an optical plate made of an optically transparent material. The finger receiving surface is illuminated by a first light source to form an image of limited size at or near the finger receiving surface. Light is collected from the finger receiving surface. The collected light is received at an imaging system to locate the position of the image along an axis of the finger receiving surface. The location of that position is compared to a predetermined reference value to determine with the object on the finger receiving is real or fake. If the object on the finger receiving surface is determined to be real, the first light source is turned off and a second light source is turned on to illuminate the finger receiving surface. Light is collected from the finger receiving surface and received at an imaging system to form an image of a fingerprint pattern of a finger based on the received light.

Various implementations of the invention may include one or more of the following features. The processing of an image of the fingerprint pattern is prevented if the object is found to be fake. The object is determined to be real only if the difference between the predetermined reference value and the measured position of the image along the axis of the finger receiving surface is less than a predetermined offset value. The diameter of the image of limited size is between about one and three millimeters.

The invention can include one or more of the following advantages. The fingerprint imaging device is reduced in size, while still providing a reliable and effective way to detect the presence of a fake or false finger. The fingerprint imaging device, because of its compact size, may be used in portable and/or compact electronic devices, such as, for example, computer notebooks, personal digital assistants, and cellular or land-based telephones. Moreover, because its components are relatively inexpensive to produce and assemble, the fingerprint imaging device is inexpensive to make. Additionally, by providing an optical approach for false or fake finger detection, the optical components of the fingerprint imaging device are used for both obtaining a fingerprint image and for detecting a false or fake finger.

The details of one or more embodiments are set forth in the accompanying drawings and the description below. Other features, objects and advantages will be apparent from the description and drawings, and from the claims.

### DESCRIPTION OF DRAWINGS

FIG. 1 shows schematically a side sectional view of a fingerprint imaging device according to the present invention.

FIG. 2 is a top view of the fingerprint imaging device taken along line 2-2 of FIG. 1.

FIG. 3 schematically illustrates, in plan view, the location of imaging areas for a fake or false finger and a real finger.

FIG. 4 schematically illustrates the relative displacement of an imaging area of a fake or false finger as compared to that of a real finger.

Like reference symbols in the various drawings indicate like elements.

### DETAILED DESCRIPTION

In the past, there has not been a need for compact fingerprint imaging devices because such devices were traditionally used in the fingerprint matching systems used in the field of criminology. However, because there are advantages to using the fingerprint as an identifier, which cannot be forgotten or lost, the field of application for fingerprint imaging devices is constantly expanding. For example, a fingerprint may be used as an access key. For instance, it may be used to access resources of different portable personal electronic apparatus. Thus, it becomes beneficial to miniaturize the fingerprint imaging device for use with such portable apparatus.

A fingerprint imaging device with a compact configuration may be implemented in a mass-produced apparatus, such as a portable electronic apparatus. Examples of portable electronic apparatus include cellular telephones, personal computers, such as notebooks, and personal digital assistants. For economic reasons, it is important that a fingerprint imaging device may be built into the portable electronic apparatus with substantially no changes in the design of those apparatus. This requirement may be met by a flat configuration of the fingerprint imaging device.

Also, it is important that if the fingerprint is used as an access key, that the fingerprint imaging device include a technique for distinguishing a real finger of an authorized user from a fake or false finger, for example, of an unauthorized user. The term “fake or false finger” includes an original fingerprint pattern imitating a finger of a person or a relief finger surface applied on an artificial object.

It is simple enough to deceive a fingerprint imaging device by using a replica of a fingerprint transferred onto a transparent film. In addition, the fingerprint can be taken unnoticed from its real owner. Also, it is possible to make an artificial finger, for example, one made of silicone or plastic, fully reproducing the fingerprint pattern of its owner. Besides, using optical contact (in the simplest case, water), it is possible to place a piece of paper or film with the fingerprint pattern on a finger receiving surface of a fingerprint imaging device.

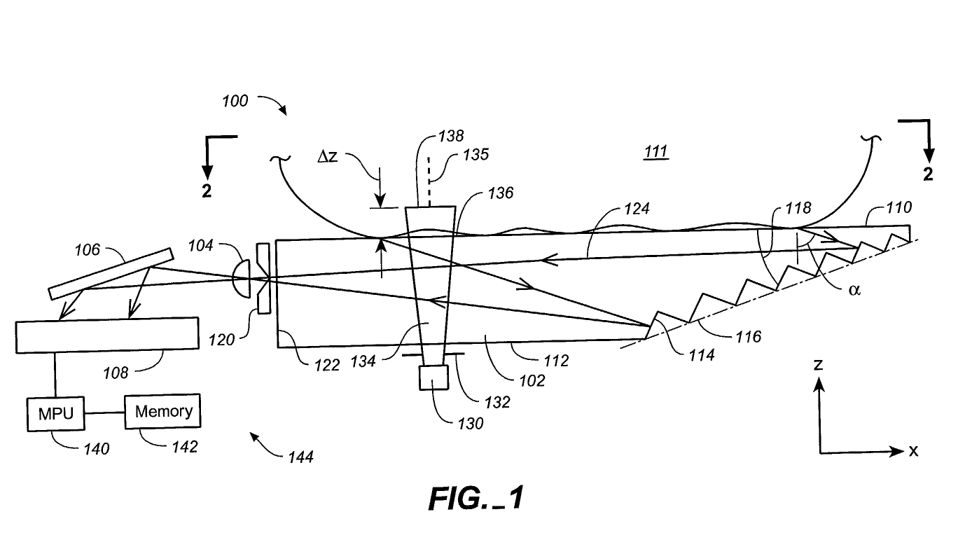

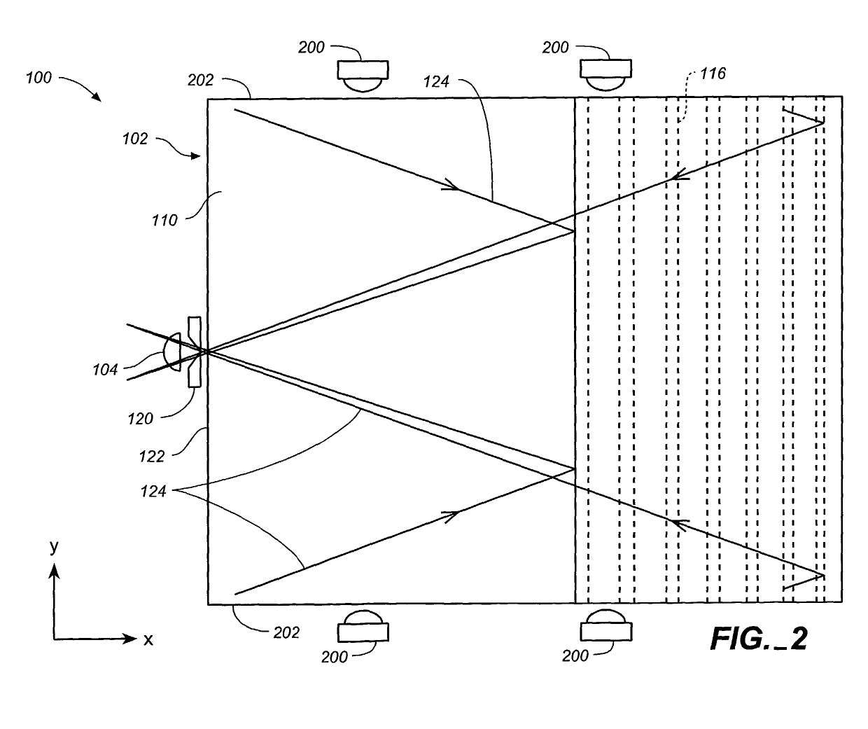

As shown in FIGS. 1 and 2, a fingerprint imaging device 100 includes an optical plate or platen 102, an imaging lens 104, a mirror 106, an image sensor 108, and one or more illuminating tools 200. For further reference, directions X and Z of the orthogonal coordinate system are shown by arrows. A third direction Y of this orthogonal coordinate system is perpendicular to the drawing plane of FIG. 1.

The optical plate 101 includes a finger field 110 located on its top. A finger or object 111 to be identified is applied to the finger field 110. A finger field 110 has an optically smooth surface to provide good contact with the finger skin ridges. The finger field regions that interface with the finger skin ridges and valleys form the fingerprint pattern. The finger field 110 has dimensions sufficient for reliable identification of the fingerprint pattern. In other words, the finger field 110 has dimensions sufficient to include the minimum required number of ridge comparisons, which may range anywhere from about 8 to about 16 comparisons. As such, dimensions of the fingerprint imaging device 100 in the Y-X plane are close to the limit imposed by the requirements of the minimum dimensions of the finger field 110. The surface of the finger field 110 may be about 18 millimeters (mm) in length and about 18 mm in width.

The mirror 106 may be any mirror or other reflective surface coated to reflect light of a wavelength produced by the one or more illuminating tools. The image sensor 108 may be a single crystal CMOS image sensor, produced by Motorola Co., Inc. Or, the image sensor may be a conventional CCD array.

The optical plate 102 includes a bottom surface 112 parallel to the finger field 110, and, for example, an array of microreflectors 114 distributed along a base surface 116 inclined to the finger field 110.

In FIG. 1, the finger field 110 and the base surface 116 are planar in shape. Other shapes are possible for either or both of these surfaces, such as, for example, cylindrical shapes, to enhance various characteristics of the fingerprint image.

The base surface 116 is inclined to the finger field 110 at an angle 118, as shown in FIG. 1. The value of angle 118 ranges from about 20 to 30 degrees.

If either or both of the surfaces 110, 116 are non-planar, then a corresponding inclination between them may be defined by a difference of distances to the finger field 110 from the edges of the base surface 116 that are farthest and nearest to the finger field 110. This difference may range from about 30 to about 50 percent of the distance between these edges.

The microreflectors 114 are formed of V-shaped grooves, with the open side of the grooves facing the imaging lens 104. The profile of the grooves is shown in FIG. 1 scaled-up relative to other parts of the device for better illustration. The grooves extend along the Y-direction. The surface of the microreflectors 114 typically has a reflecting coating, which, for example, may be a deposited layer of aluminum.

The imaging lens 104 has an aperture stop 120 that is positioned external to the optical plate 102 and behind its lateral surface 122. The aperture stop 120 defines an aperture light beam of imaging light rays forming the image of a fingerprint pattern. In general, imaging light rays that reach the aperture stop 120 are converging. However, for the purpose of illustration, imaging light rays appear parallel.

The imaging lens 104 creates the image of the fingerprint pattern of the imaging light rays reflected from the microreflectors 114. The directions of propagation of imaging light rays in the fingerprint imaging device are shown by lines 124. The mirror 106 serves to reflect imaging light rays passed through the imaging lens 104 to the image sensor 108, so that the image sensor 108 is positioned in the plane of the optical plate 102 and does not increase the overall height of the fingerprint imaging device 100 in the Z-direction.

As shown in FIG. 2, the illuminating tools 200 are arranged and operated to illuminate the finger field 110. The illuminating tools 200 may be radiation sources that illuminate the finger field 110 from two opposite directions through lateral surfaces 202 of the optical plate 102. The illuminating tools 200 are represented by conventional light-emitting diodes irradiating in the red spectral region, with a radiation spectral width of approximately 50 nanometers (nm).

The illuminating tools 200 emit radiation evenly. However, inside the optical plate 102, a refracted light beam from each radiation source 200 propagates within the limits of an associated restricted solid angle of about 80 degrees in cross-section. Light from the illuminating tools 200 that is totally internally reflected inside the optical plate 102 is not involved in the fingerprint pattern imaging.

When a finger is applied to the finger field 110, in the regions of its surface having boundaries with the finger ridges, the total internal reflection conditions are not met for light from the illuminating tools 200. Imaging light rays penetrate through the surface of the finger field 110 and illuminate the finger skin on its ridges. Imaging light rays scattered from the ridges pass back into the optical plate 102 in accordance with the refraction law at angles to the normal of the surface not exceeding the critical total internal reflection angle at the interface with the ridges. These imaging light rays create a negative fingerprint pattern formed by the bright regions corresponding to the ridges of the finger skin, as the valleys of the finger skin produce a dark background.

The illuminating tools 200 are positioned so as not to protrude beyond a height of the optical plate along the Z direction. Thus, the height of the fingerprint imaging device 100 in the Z direction is determined by the thickness of the optical plate 102.

The microreflectors 114 are distributed with a spacing along the base surface designated by line 116. For economic reasons, device materials such as acrylic plastics or polystyrene are used for the optical plate 102. In this case, the grooves on the surface of a die used to manufacture the optical plate 102 may be formed using a fabrication process similar to that employed in making diffraction gratings, which would provide the required optical quality for the surfaces of the microreflectors. The microreflectors 114 subtend an angle with the base surface 116.

With values of the angle 118 ranging between about 20 to about 30 degrees, the spacing between the microreflectors is approximately twice the width of the projection of a microreflector to the base surface 102 along the path of the incident light rays. With these conditions, and if the surface of the finger field 110 is about 18 mm in length and about 18 mm in width, the optical plate 102 may be designed to be no more than 3 mm thick (as measured along the Z-direction).

The resolution of the fingerprint imaging device 100 in the Y direction is determined by the resolution of the imaging lens 104. The resolution of the fingerprint imaging device 100 in the X direction is dependent on the relationship between the spacing of the microreflectors 114 and the cross-sectional dimensions of the aperture light beam at the base surface 116.

To obtain a high quality fingerprint image, the cross-sectional dimension of the aperture light beam at the base surface 116, transversely to the microreflectors 114, should be approximately twice the spacing of the microreflectors 114. In this case, the structure of the array of microreflectors 114 may not reveal itself in brightness modulation of the image, and degradation of the fingerprint imaging device resolution along the X-direction, as compared to the resolution along the Z-direction, is negligible.

The cross-sectional dimensions of the aperture light beam at the base surface 116 are proportional to the distance along its axis from the base surface 116 to the finger field 110. To provide a uniform resolution over the image field, the microreflectors 114 may be arranged with a variable spacing along the base surface 116, which is proportional to the distance from them to the finger field 110 along the imaging light rays.

In this case, the spacing of the microreflectors 114 is changed linearly ranging from about 0.05 mm near the finger field 110 to about 0.3 mm at the surface 112. With such variable spacing, the difference between the optical path lengths for the rays reflected by adjacent microreflectors is in excess of the coherence interval of the imaging light rays, which is determined by the spectral width of light radiated by the illuminating tools 200. With a spectral width of about 50 nm, which is characteristic of conventional light emitting diodes, the coherence interval is about 0.015 mm. Thus, the imaging light rays reflected by different microreflectors are substantially incoherent. The coherence interval of light radiated from the illuminating tool 200 may be less than the optical path length difference between parts of the aperture light beam reflected from different microreflectors.

The fingerprint imaging device 100 further includes a light source 130. This light source is used to determine whether an object on the finger field 110 is real or fake.

The light source 130, through an aperture 132, illuminates a relatively small area of the surface of the finger field 110 with a relatively narrow light beam 134. The light beam 134 should illuminate at least three ridges of a fingerprint pattern. The light beam should also be large enough so that any shift of the image area formed by the light beam 134, as discussed below, can be detected by the image sensor 108. Thus, the diameter of the image formed by the light beam 134 may be on the order of about one to three mm for an aperture diameter of about 0.4 mm.

As shown, the light beam 134 may have a central axis 135 that is substantially normal to the surface of the finger field 110. Alternatively, the central axis of the light beam may be located at an angle other than 90° relative to the surface of the finger field. The light source 130, for example, may be a laser, a light emitting diode or a laser diode.

Additionally, as shown in FIG. 1, the fingerprint imaging device 100 includes a microprocessor unit (MPU) 140 for, among other things, comparing fingerprint image data from the image sensor 108 to fingerprint image data, for example, of an authorized user stored in a memory 142. The MPU 140 also controls the operation of the image sensor 108, the light source 130 and the illumination tools 200. The image sensor 108, the MPU 140, and the memory 142 are part of a fingerprint imaging system 144. The imaging lens 104, the mirror 106 and the aperture stop 120 are also part of the imaging system 144.

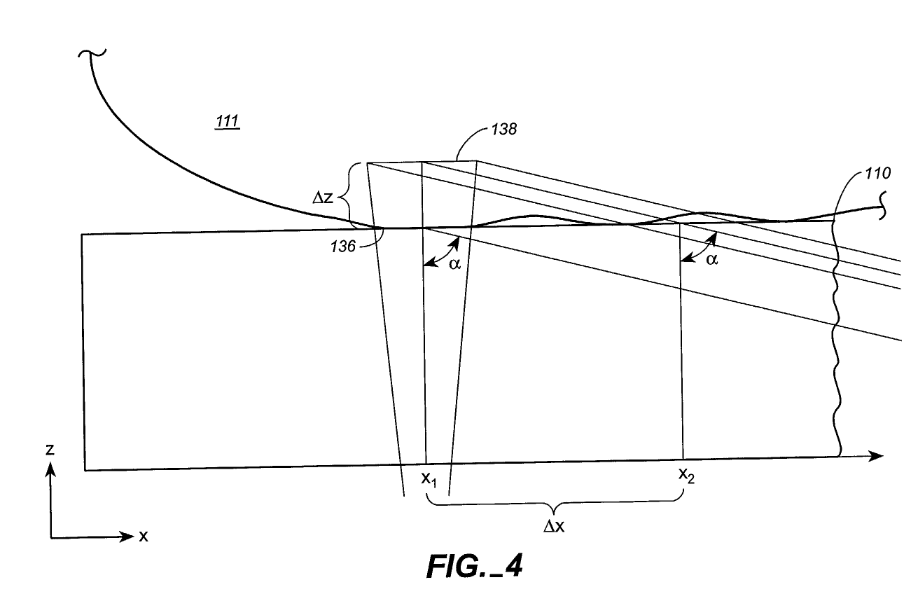

In operation, a finger 111 on the finger field 110 is illuminated by the illumination tools 200. At an observation angle α measured with respect to a normal to the finger field (see FIGS. 1 and 4), the light 124, as discussed, strikes the microreflectors 114 and then after passing through the aperture stop 120 and the lens 104, and being reflected by the mirror 106, strikes the image sensor 108 to produce a fingerprint pattern.

However, prior to imaging an object on the finger field with the illumination tools 200, the light source 130 is operated to determine whether the object on the finger field is real or fake. Specifically, with the illumination tools 200 off, the light source 130 is operated to illuminate a relatively small portion or image area of the surface of the finger field 110.

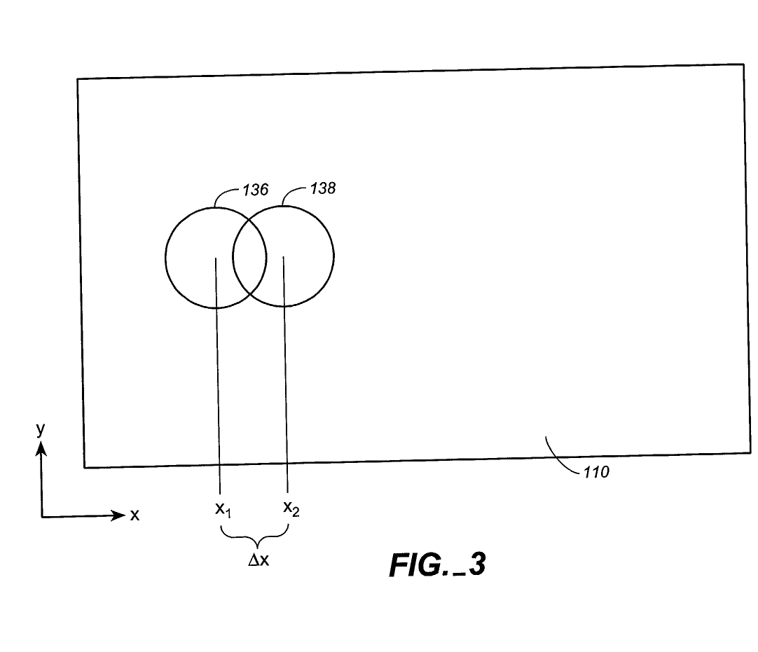

If an opaque object, such as a fake or false finger, for example, an artificial finger made of a plastic, is present on the finger field 110, a light spot or image area 136, as shown in FIGS. 1, 3 and 4, is formed on the finger field. However, if a real finger is on the finger field 110, then due to the transparency of real finger skin, a light spot or image area 138 is formed deeper in the finger at a distance or displacement ΔZ from the finger field 110. This displacement ΔZ, in one configuration, may be approximately equal to 0.5 mm.

If the image areas 136 and 138 are viewed from the direction of the imaging lens 104 at the observation angle α, which may be on the order of bout 75°, it can be seen that the image area 138 (having its center at X₂) is shifted along the X axis, the displacement ΔX, with respect to the image area 136 (having its center at X₁) by a value:

$$Δ X = {X}_{2} - {X}_{1} = \frac{Δ Z}{T g ( 90 - α )} = \frac{0.5}{T g ( 15 ) °} ≅ 2 mm$$

A predetermined offset value, for example, ΔX≡2 mm, can be fixed in the memory 142 of the imaging system 144. Thus, if the MPU 140 determines that the measured value of ΔX, with the light source 130 on and the illumination tools 200 off, is greater than, or greater than or equal to the predetermined offset value, then the fingerprint imaging system will determine that the object on the finger field 110 is not real. Conversely, if the measured value of ΔX is less than the predetermined offset value, the object on the field is determined to be real.

In other words, the position of an image by directing light from the light source 130 onto a real finger on the finger field 110 is detected. The coordinates of that image area or spot 138 are determined by the MPU 140 and stored in the memory 142 as a predetermined reference value.

The position of an image area or spot 136 from a fake finger on the finger field 110 has coordinates that are different from the coordinates of the image area 138 of a real finger. Thus, in use, the coordinates of the image area generated by the light beam 134 are measured or determined, and they are compared with the real finger image coordinates, the predetermined reference value, stored in memory. If the difference between the two exceeds, alternatively, or is the same or greater than, the predetermined offset value, the finger is identified as not real. If this measured difference is less than the predetermined offset value, the object is identified as a real finger. Thus, the imaging system 144 will not identify an object as fake or false, if the measured difference is less than the predetermined offset value.

Alternatively, an object could be determined to be false if the measured coordinates of the object image area are not the same as the predetermined reference value. However, such a technique could possibly lead to incorrectly identifying a real finger as false, as the measured coordinates or value between two real finger image may be slightly different. The use of a predetermined offset value substantially reduces the chance that a real finger will be identified as fake.

If it is determined that the object on the finger field 110 is real, the light source 130 will be turned off, and the illumination tools 200 will be turned on to generate a fingerprint image for processing by the imaging system 144. However, if the object on the finger field 110 is found to be false or fake, the imaging system will disable processing of any fingerprint images, and an audible, visual or some other form of an alarm may be generated.

A number of implementations and techniques have been described. However, it will be understood that various modifications may be made to the described components and techniques. For example, advantageous results still could be achieved if steps of the disclosed techniques were performed in a different order, or if components in the disclosed systems were combined in a different manner, or replaced or supplemented by other components.

For example, in contrast to the arrangement of FIGS. 1 and 2, the illuminating tools 200 in the fingerprint imaging device 100 may be placed behind the surface 122 and on either or both sides of the aperture stop 120 to create a positive fingerprint pattern. In this case, the illuminating tools 200 may be extended radiation sources having even brightness.

Another possible embodiment of the fingerprint imaging device is that in which the base surface is located parallel to the finger field. Additionally, a separate image sensor (not shown) may be used to determine whether the displacement between two image areas is indicative of a real or fake finger.

Also, the present invention may be used with various types of fingerprint imaging devices. For example, it may be used with a fingerprint imaging device that uses a converging mirror or a diverging mirror in place of the microreflectors. Such devices are disclosed in U.S. patent application Ser. No. 09/915,754, filed Jul. 27, 2001, entitled FINGERPRINT IMAGING DEVICE, assigned to the assignee of the subject application, the entire disclosure of which is incorporated herein by reference.

A number of embodiments of the invention have been described. Nevertheless, it will be understood that various modifications may be made without departing from the spirit and scope of the invention.

What is claimed is:

1. An imaging device comprising:
an optical plate made of an optically transparent material and forming a surface to receive a finger;
a first light source positioned to illuminate the finger receiving surface;
an imaging system positioned to receive light collected from the finger receiving surface and to form an image of a fingerprint pattern of a finger on the finger receiving surface; and
a second light source to direct a light beam to the finger receiving surface to determine whether an object on the finger receiving surface is real or fake.

2. The device of claim 1 wherein the light beam from the second light source has a central axis that is normal to the finger receiving surface.

3. The device of claim 1 wherein the light beam from the second light source has a central axis that is inclined at an angle from normal relative to the finger receiving surface.

4. The device of claim 1 in which an image area of the light beam from the second light source is substantially less than the surface area of the finger receiving surface.

5. The device of claim 4 in which the diameter of the image area of the light beam from the second light source is between about one and three millimeters.

6. The device of claim 1 in which the second light source is selected from the group consisting of a light-emitting diode, a laser and a laser diode.

7. The device of claim 1 in which the optical plate has a second surface parallel to the finger receiving surface, the second light source being located below the second surface of the optical plate.

8. The device of claim 7 in which the first light source is positioned at the second surface of the optical plate.

9. The device of claim 7 further including a reflective surface positioned at a third surface of the optical plate to collect light from the finger receiving surface and to focus the collected light on the imaging system.

10. The device of claim 9 in which the imaging system is positioned at a fourth surface of the optical plate.

11. The device of claim 9 in which the reflective surface is a converging mirror, a diverging mirror or an array of microflectors.

12. The device of claim 1 in which the imaging system comprises:
an aperture at a second surface of the optical plate ;
an objective at the aperture; and
a detector to receive light collected by the aperture and the objective.

13. The device of claim 12 in which the imaging system comprises a reflective surface positioned between the objective and the detector for collecting light from the objective and for focusing the light onto the detector.

14. The device of claim 12 in which the detector comprises a CCD.

15. The device of claim 12 in which the detector comprises a CMOS sensor.

16. The device of claim 12 in which the aperture defines an aperture beam of light rays used by the detector.

17. An imaging device comprising:
an optical plate made of an optically transparent material and forming a surface for receiving a finger;
a first light source positioned to illuminate the finger receiving surface;
a second light source to direct a light beam toward the finger receiving surface to form an image of limited area at or near the finger receiving surface; and
an imaging system positioned to receive light from the finger receiving surface and to form an image of a fingerprint pattern of a finger on the finger receiving surface, the imaging system configured and operable to locate the position of the image formed by the second light source along an axis of the finger receiving surface and to compare that position to a predetermined reference value to determine whether an object on the finger receiving surface is real or fake.

18. The device of claim 17 wherein the predetermined reference value is stored in memory and is the position of an image formed along the axis of the finger receiving surface by a real finger, and further including a predetermined offset value stored in memory that is the approximate difference between the predetermined reference value and the position of an image formed along the axis of the finger receiving surface by a fake or false finger.

19. The device of claim 18 wherein the imaging system further includes a processor to compare the predetermined reference value to the position of the image formed by the second light source along the axis of the finger receiving surface to generate a measured offset value that is compared to the predetermined offset value to determine whether the object on the finger receiving surface is real or false.

20. An imaging device comprising:
an optical plate made of an optically transparent material and forming a surface for receiving a finger;
a light source to direct light to the finger receiving surface to form an image of limited size at or near the finger receiving surface to determine whether an object on the finger receiving surface is real or fake; and
an imaging system positioned to receive light collected from the finger receiving surface to locate the position of the image formed by the light source along an axis of the finger receiving surface and to compare that position to a predetermined reference value to determine whether an object on the finger receiving surface is real or fake.

21. The device of claim 20 wherein the imaging system is configured and operable to form an image of a fingerprint pattern of a finger on the finger receiving surface.

22. An imaging device comprising:
an optical plate made of an optically transparent material and forming a surface for receiving a finger;
a first light source positioned to illuminate the finger receiving surface;
a second light source to direct a light beam toward the finger receiving surface to form an image of limited area at or near the finger receiving surface; and
an imaging system positioned to receive light from the finger receiving surface and to form an image of a fingerprint pattern of a finger on the finger receiving surface, the imaging system including means for locating the position of the image formed by the second light source along an axis of the finger receiving surface and comparing that position to a predetermined reference value to determine whether an object on the finger receiving surface is real or fake.

23. A method of imaging a fingerprint, the method comprising:
receiving an object at a finger receiving surface of an optical plate made of an optically transparent material;
illuminating the finger receiving surface with a light source to form an image of limited size at or near the finger receiving surface;
collecting light from the finger receiving surface; and
receiving the collected light at an imaging system to locate the position of the image along an axis of the finger receiving surface and to compare it to a predetermined reference value to determine whether the object on the finger receiving surface is a real or fake.

24. A method of imaging a fingerprint, the method of comprising:
receiving an object at a finger receiving surface of an optical plate made of an optically transparent material;
illuminating the finger receiving surface with a first light source to form an image of limited size at or near the finger receiving surface;
collecting light from the finger receiving surface;
receiving the collected light at an imaging system to locate the position of the image along an axis of the finger receiving surface and to compare it to a predetermined reference value to determine whether the object on the finger receiving surface is a real or fake;
if the object on the finger receiving surface is determined to be real, turning off the first light source and turning on a second light source to illuminate the finger receiving surface;
collecting light from the finger receiving surface; and
receiving the collected light at an imaging system to form an image of a fingerprint pattern of a finger based on the received light.

25. The method of claim 24 further including preventing processing of the image of the fingerprint pattern if the object is found to be fake.

26. The method of claim 24 wherein the object is determined to be real only if the difference between the predetermined reference value and the measured position of the image along the axis of the finger receiving surface is less than a predetermined offset value.

27. The method of claim 24 in which the diameter of the image of limited size is between about one and three millimeters.
